(19) United States
(12) Patent Application Publication
(10) Pub. No.: US 2020/0363821 A1
(43) Pub. Date: Nov. 19, 2020

(54) SYSTEM AND METHOD FOR STABILIZING AND RESTRAINING AIR DISTURBANCES ON ELECTRICALLY PROPELLED AIRCRAFT

(71) Applicant: Eviation Tech Ltd, Kadima Tzoran (IL)

(72) Inventors: Aviv TZIDON, Tel-Aviv (IL); Omer BAR YOHAI, Sde Itzhak (IL); Avraham DAVIDOVITCH, Kadima Tzoran (IL); Dekel TZIDON, Hod HaSharon (IL)

(73) Assignee: Eviation Tech Ltd, Kadima Tzoran (IL)

(21) Appl. No.: 16/762,177

(22) PCT Filed: Nov. 7, 2018
(86) PCT No.: PCT/IL2018/051195

§ 371 Date: May 7, 2020

Related U.S. Application Data
(60) Provisional application No. 62/582,334, filed on Nov. 7, 2017.

(51) Int. Cl. G05D 1/08; B64D 27/24; B64D 31/06; B64C 11/30; B64C 11/46; G08G 5/00

(52) U.S. Cl. CPC G05D 1/0816; B64D 27/24; G08G 5/0047; B64C 11/30; B64C 11/46; B64D 31/06

(57) ABSTRACT

A control system and a method are adapted to restrain turbulence induced yaw or side movements of an airborne vehicle (AV) that has at least two electrical motors, the motors are disposed one on the left and one on the right side of a longitudinal central axis of the AV. The system comprises a controller that is adapted to receive indications of ambient induced yaw and/or lateral movements of an airborne vehicle and pilot induced control signals of the airborne vehicle, and to issue control signals to control the RPM and/or the propeller pitch angle of the electrically propelled airborne vehicle.

### BACKGROUND OF THE INVENTION

Airborne vehicles are subject to disturbances during flight, such as rapid changes in wind speed, wind shears, air bumps and other phenomenon that cause local irregularities in the air density and velocity (collectively-in the specific total energy per volume unit) in the vicinity of the airborne vehicle (AV). Typically, fixed wings AVs are built with inherent aerodynamic stability aimed to restrain the effect of disturbances and maintain the AV stable when exposed to disturbances.

Stability of an AV may be provided, by the design of its aerodynamic plain form in the horizontal & vertical plains. For example, stability in the yaw axis may be achieved by the tail vertical stabilizer surface, which when a disturbance causes undesired change in the yaw plane/sideslip angle, the aerodynamic develops yaw moment on the tail vertical stabilizer surface, that acts in a direction to return the AV to zero sideslip angle. Yet, such correction, caused by the inherent stability, is adapted to cancel/minimize the sideslip angle, but since the stabilizing action is produced by the vertical stabilizer surface, which is located off the CG point, it may not provide counter-force that will cancel the sideslip movement of the AV caused by the lateral aerodynamic forces.

Pilot or autopilot induced corrections to bumps, shaking or other types of momentary lateral disturbances may only partially be handled by operating the vertical rudder to correct the induced yaw disturbance, by cancelling the nose direction's deviation. However, the sideslip of the AV resulting from lateral aerodynamic disturbance may not be eliminated merely via operation of the vertical rudder.

There is a need to provide system, means and method for restraining and limiting yaw and sideslip effect of lateral forces acting on the AV, e.g. due to air bumps or side winds, so that the CG of the AV will experience substantially zero sideslip movement and zero yaw disturbances.

There is a need to provide system, means and method for restraining side movements at crosswind landing, simplifying the required maneuver, enabling safe landing and reducing the time for pilots training.

There is a need to provide system, means and method for restraining side movements at crosswind landing, while maintaining zero or close to zero bank angle, enabling safer landing by reducing the risk of hitting the ground with the wingtip, wingtip mounted propeller, etc.

### SUMMARY OF THE INVENTION

A control system is disclosed adapted to restrain turbulence induced yaw or side movements of an airborne vehicle (AV) that has at least two electrical motors disposed one on the left wing and one on the right wing of the AV, the system comprising a controller that is adapted to receive indications of ambient induced yaw and/or lateral movements of an airborne vehicle and pilot induced yaw control signals of the airborne vehicle, and to issue control signals to at least one of the at least two electrical motors of the airborne vehicle. In some embodiments the system is adapted to compensate the effect of the ambient induced yaw and/or lateral movements.

Throughout the description of embodiments of the invention herein below where an electrical motor is described it should be understood that that motor is equipped with thrust generating means such as propeller or fan, and that when control of the motor is discussed it should be understood that the control of the motor (e.g control of its RPM) controls also the thrust generated by that motor.

In some embodiments the control system is further adapted to calculate the required changes of thrust provided by propellers powered each by the at least two electrical motors to compensate is for the at least one of yaw and lateral movements and to provide control signals to at least one of the at least two electrical motors of the AV to effect the calculated required changes of thrust.

In some embodiments the control system is further adapted to calculate the required changes of the angle of attack of a tail rudder of the AV to compensate for the at least one of yaw and lateral movements and to provide the signals required to change the tail rudder angle of attack.

In some embodiments the control signals are further translated to effect at least one of propellers pitch of the at least one propeller and the electrical motor RPM of at least one electrical motor.

In some embodiments the control system is further adapted to calculate and provide the required control signals at a response time that is at least ten times faster than the time between yaw or lateral induced changes of movements.

An electrically propelled airborne vehicle (AV) is disclosed having at least two electrical motors disposed one on the left wing and one on the right wing of the AV, the electrically propelled AV comprising a yaw or side movement restrain system to allow stable flight in higher flight speeds/bad weather conditions. The restrain system comprising a controller adapted to receive indications of ambient induced yaw and/or lateral movements of an airborne vehicle and to issue control signals to at least one of the at least two electrical motors of the airborne vehicle.

In some embodiments the control system is further adapted to compensate for effects of cross wind.

In some embodiments the control system is further adapted to compensate for effect of crosswind during landing so as to allow landing at substantially zero bank angle.

In some embodiments the controller is further adapted to receive indications of ambient status ahead of the AV with respect to the AV flight direction, from at least one of the AV weather RADAR, a ground weather RADAR and wing member weather RADAR.

In some embodiments each of the two electrical motors is disposed in one form from a list consisting AV main wing, AV rear wing, AV V-tail stabilizer.

A method for restraining ambient induced yaw or side movements in an airborne vehicle (AV) is disclosed, the AV having at least two electrically powered propellers disposed one on the left wing and one on the right wing of the AV and a control system. The method comprising receiving by the control system indications of at least one of yaw and lateral movements, calculating by the control system the required changes of thrust provided by at least one of the at least two electrically powered propellers of the AV based on the received indications and continuously providing by the control system first signal to the at least one left and at least one right electrical motors, so as to minimize the effect of the yaw and/or side movement on the airborne vehicle.

In some embodiments the method further comprising receiving by the control system lateral movement indications, calculating by the control system the required changes of thrust provided by at least one of the at least two electrically powered propellers of the AV based on the received indications, and the required changes in the position of the tail rudder of the AV and continuously providing by the control system first signal to the at least one left and at least one right electrical motors and rudder position, so as to minimize the effect of the crosswind on the side movement on the airborne vehicle.

In some embodiments the controller is adapted to continuously provide first signal to the at least one left and at least one right electrical motors and rudder position, so as to enable completing the landing with AV roll angle no greater than two degrees in view of a cross wind that is up to 15% of the landing speed of the AV.

In some embodiments the method further comprising calculating by the control system the required tail rudder change of angle of attack to direct the vehicle to a desired direction based on the received indications and continuously providing by the control system a second signal to the tail rudder so as to minimize the effect of the yaw and side movement on the airborne vehicle.

In some embodiments the yaw and/or lateral movement indications are measured on the airborne vehicle.

In some embodiments at least one of the yaw and the lateral movements are measured ahead of the airborne vehicle in the direction of its movement.

In some embodiments the indications of the at least one of the yaw and the lateral movements are considered as reflecting ambient induced disturbances at a location that is distal, in time domain, from the airborne vehicle by time T1 and wherein the controller is adapted to calculate the required changes within time T2 that is at least ten times shorter than T1.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of forces acting on an airborne vehicle (AV);

FIG. 2 is a schematic illustration of AV operative according to embodiments of the present invention;

FIG. 3 is a schematic block diagram of a controller adapted to provide yaw movements correction signals, according to embodiments of the present invention;

FIG. 4 is a top view schematic illustration of forces acting on an airborne vehicle when subjected to lateral continuous or gustily wind;

FIG. 5 is a front-view schematic illustration of forces acting on an airborne vehicle (AV) when subjected to lateral continuous or gustily wind;

FIG. 6 is a top view schematic illustration of forces acting on airborne vehicle (AV) operative according to embodiments of the present invention, when subjected to lateral continuous or gustily wind; and

FIG. 7 is a schematic illustration of forces exerted on an AV when side motors are operated in a differential manner, enabling to land in view of cross wind with substantially zero bank angle, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

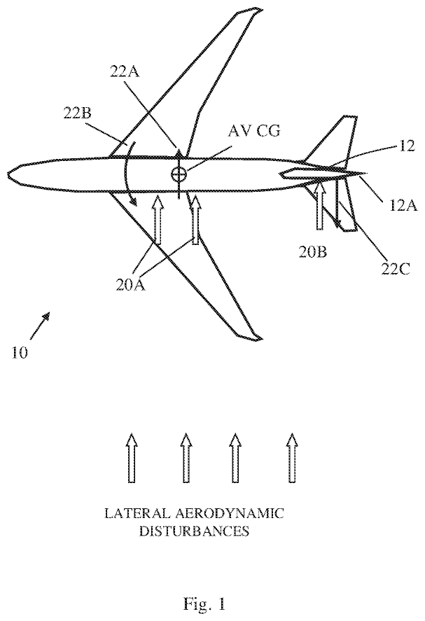

Reference is made now to FIG. 1, which is a schematic illustration of forces acting on an airborne vehicle (AV) 10 when subjected to lateral aerodynamic forces. The side profile of AV 10 is not symmetric about its CG point. The vertical stabilizer surface 12 presents a relatively large aerodynamic surface extending from the AV10 body proximal to its rear end. Lateral aerodynamic forces 20A, 20B acting on the AV body and on the vertical stabilizer surface, respectively, cause sideslip linear acceleration/movement represented by arrow 22A acting on the CG point, and yaw angular acceleration/movement represented by arrow 22B, acting about the CG point. Vertical rudder 12A may be operated to limit or cancel the yaw angular moment 22B by changing its angle to produce aerodynamic force 22C, substantially with same magnitude and opposite direction compared to yaw moment 22B. While the vertical steering means is capable of limiting or cancelling the sideslip angle, the side linear movement/acceleration (e.g. 22A) may not be corrected or cancelled merely by means of aerodynamic steering means of the AV.

At cruise flight, as is known in the art, the aerodynamic lift of an Aircraft (A/C) equals the A/C mass. The aerodynamic drag is typically 1/20 the aerodynamic lift—the A/C mass. The engines thrust, equals the aerodynamic drag. Assuming the angle of attack at cruising speed is about 4°, the side force acting on the A/C due to one percent (0.573°) of A/C speed wind sheer (cross wind) is about 1/7 of the lift (A/C mass) times the ratio between the A/C side force curve slope—C_{Yβ}and the lift curve slope—C_{Lα}, typically 1/15. So the side force magnitude due to 1 percent wind sheer is about 1/105 of the lift force.

Typically the ruder area is about 1/60 of the A/C horizontal surfaces area, so a rudder angle of: 60/105*1%=0.57% (0.33°) is needed to compensate this side force perturbation.

Typically for A/C with twin air-breathing engines the distance between them is about 0.6 of the distance between the ruder and the A/C center of gravity (CG). The total thrust as mentioned above, is 1/20 of the A/C lift. Accordingly, each engine thrust is 1/40 of the total lift. Therefore, in order to compensate the yaw moment due to ruder deflection of 0.36°, a thrust change of 1/105/0.6=1/63 (0.0159) of the total lift will be required. It means that one engine will run up to produce 0.0329 (0.5/63+1/40) instead of 0.025 of the total lift and the other engine will slow down to reduce its thrust from 0.025 to 0.0171 (1/40−0.5/63) of the total lift.

Such change in the engines thrust, −31.6% of the cruising thrust, cannot be performed by air-breathing engines in short time to be significant for Yaw perturbations canceling. Typically time for such thrust changing is in the magnitude of 2-3 seconds during which time the A/C moves forward a distance equal to 10 times its length. It is obvious that such sluggish power system cannot take part in the Yaw perturbations restraining process.

Yet, advantage of an electrically powered NC may be taken. Electric (EL) motor is torque tighten controlled in close, loop. The time needed to change its output power is only a question of the propeller inertia and the maximal electric input torque. At cruise flight, the output power of the EL motor is less the quarter of its maximal power so elevating its output power by 30% should not take more than, for example, 0.04÷0.06 second, either by accelerating the propeller turning rate, either by enlarging/reducing the propeller pitch angle or by any combination of both.

The small size (and mass) of EL motor enables attaching it to the A/C wing tips. So the distance between twin motors at A/C wing tips is now typically 2 times the distance between the ruder and the A/C CG. Thus reducing dramatically the amount of thrust change needed to oppose the ruder yaw moment from 31.6% to just 31.6*0.6/2=9.5%. So it is a straight forward to close side force loop involving sideslip angle change measuring just in front of the A/C and simultaneously controlling the ruder deflection angle and the twin EL motors torque and angular velocity, to cancel the upcoming unpleasant side force due to the yaw perturbation. The conventional A/C autopilot is running in parallel to eliminate the secondary effect of rolling moment due to the ruder deflection. Consequently, smooth and pleasant flight continues undisturbed.

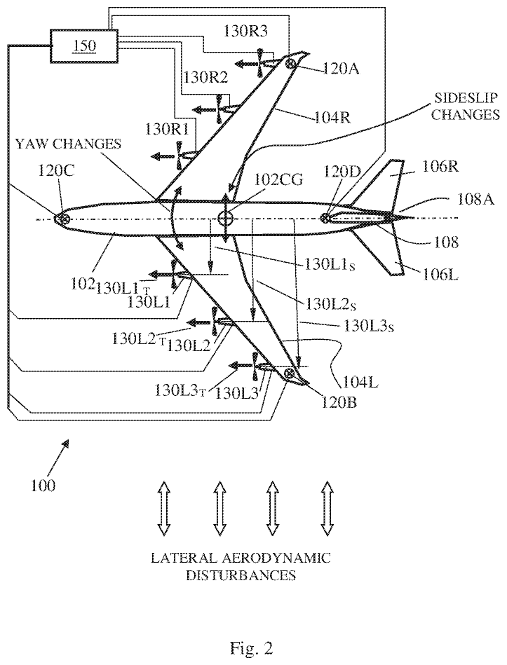

Reference is made now to FIG. 2, which is a schematic illustration of airborne vehicle (AV) 100 operative according to embodiments of the present invention AV 100 may be generally structured as is known in the art. AV 100 comprise main fuselage 102, left and right wings 104L, 104R, respectively, left and right horizontal stabilizers (‘rear wings’) 106L, 106R, respectively, and vertical stabilizer (‘tail’) 108 with vertical rudder 108A, AV center of gravity 102CG, typically located on the central longitudinal axis and at a distance from the nose. It will be noted that the shape of AV 100 in FIG. 2 is schematic and that other shapes of a fixed-wing aircraft may be used, e.g. having V-shaped tail system, and/or having, additionally, electrical motors installed at the tips of the horizontal stabilizers 106L,106R.

AV 100 may be propelled by a plurality of electrical motors 130L1-130L3 on the left side and 130R1-130R3 on the right side of AV 100. It will be noted that the number of electrical motors on each side of AV 100 may he one or more and that the leftmost and rightmost motors are preferably located close to the respective wings' tip and preferably turning, each, in a direction countering the direction of the wing tip vortex next to it. Each of the motors is capable of providing respective thrust 130Lx_{T} on the left side (1≤×≤N; 1≤N) and thrust 130Rx_{T} on the right side (1≤×≤N; 1≤N). The thrust provided by each of the motors may be controlled by a controller in the range of 0≤130L/Rx_{T}≤100%. The thrust of each of the motors is acting remotely from the center of gravity 102CG by a specific distance 130L/Rx_{S} respectively. The moment provided by each of the electrical motors about the center of gravity 102CG is the product of the thrust and its respective distance and with the respective moment direction (or mathematical sign +/−).

As seen in FIG. 2, in case it is desired to interfere with yaw disturbances the leftmost and rightmost electrical motors should preferably be used, because their moment about 102CG is the highest, however, other motors or combinations of motors may be used. In the example of FIG. 2, the yaw moment provided by the left most motor is LM_{MOMEMT}=+130L3_{T}×130L3_{S}. The moment that the right most electrical motor may provide is RM_{MOMEMT}=−130R3_{T}×130R3_{S}. Since the distances of the left most and rightmost motors is the same, and the maximum available thrust of the motors is expected to be substantially the same, the maximum dynamic range of changes of the combined moment provided by these motors may be expressed by:

YAW Moment=±130R3_{T}×130R3_{S}

and when the thrust of the left and right motors is equal the combined moment is zero.

The fast response of electrical motors to thrust changes command, as may be provided, for example, by control unit 150, may advantageously be used to handle side accelerations caused by side aerodynamic disturbances. The momentary thrust of each motor 130Rx, 130Lx and the side acting aerodynamic force provided by the vertical stabilizer 108 and the vertical rudder 108A may be set so that the total moments provided will set the sideslip angle to zero and the total aerodynamic linear force provided by the vertical stabilizer (e.g. 22C in FIG. 1) will be equal in magnitude and opposite in direction to the momentary linear sideslip caused by the side aerodynamic disturbances.

It will be apparent to those skilled in the art that other pairs of motors may be used for this purpose, and/or more than one motor on each side may be used, as well as a non-symmetric combination (e.g. in case of a malfunctioning motor).

AV 100 further comprises at least one yaw movement sensor/indicator 120A-120D. As seen in FIG. 2, yaw movement/acceleration indicator may be located in one or more locations on AV 100, preferably distal from center of gravity (and center of yaw movements) e.g. at the wings tips, at the fuselage nose and fuselage tail, to produce more accurate yaw movements indications. In some embodiments, the sensor may be disposed ahead of the aircraft nose, to provide more accurate and earlier readings of developing disturbances. Movement indicators 120A-120D may be any known movement/acceleration or other type of indicator, that is able to provide sufficient accurate and fast indication of a change in the yaw position, speed and acceleration, so as to enable sufficiently accurate readings of the developing changes, and thereby sufficiently accurate computing and issuing of correction signals to the electrical motors participating in providing yaw and/or side acceleration correction thrust, e.g. motors 130L3 and 130R3, and to the vertical stabilizer and rudder. See herein above exemplary calculations of magnitude of required correction vector and response times, aiming to provide yaw corrections so that yaw disturbances are virtually unfelt onboard the aircraft. In some embodiments, the movement sensor may be adapted to sense the movement changes using sensing means other than movement acceleration sensors, e.g. means for sensing the change of location of the AV based on external location measuring means (e.g. global location system, telemetry system, and the like).

AV 100 comprises controller 150 in active communication with electrical motors 130, with movements and acceleration indication signals 120A-120D and with at least the vertical rudder 108A actuator, to issue thrust control signals, yaw changes signals and to receive yaw movement and acceleration changes signals. Controller 150 may further receive indications from the pilot's is flight control means, to receive indications of pilot induced flight changes, in order to better identify undesired yaw movements/accelerations,

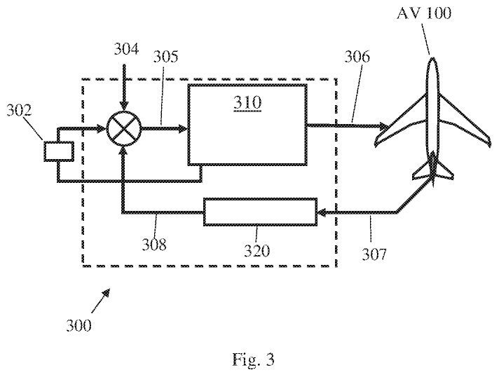

Reference is made now to FIG. 3, which is a schematic block diagram of controller 300, adapted to provide yaw movements correction signals, such as controller 150 of FIG. 2, according to embodiments of the present invention. Controller 300 may comprise control signals computing unit 310, and control loop and feedback unit 320. Controller 300 may receive pilot induced control signals 304 and yaw movement (linear/rotational; linear in time or accelerations) changes signals 307. Controller 300 may further receive pilot selection of yaw restraining profile setting 302, e.g. selecting the nature and ‘touch and feel’ of the requested yaw restraining profile. Inputs 302 and 304 and feedback signal 308 may be ‘summed’ (or otherwise combined, as may be desired) at summing point 303 to issue a combined control set signal 305. The computed output signal 306 is issued to set the momentary thrust of electrical motors such as electrical motors 130L/R3 of FIG. 2 and the momentary setting of the vertical rudder, such as rudder 108A of FIG. 2.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

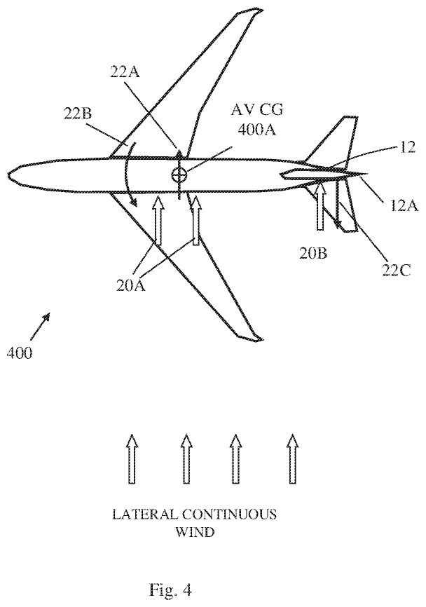

Reference is made now to FIG. 4, which is a top view schematic illustration of forces acting on an airborne vehicle (AV) 400 when subjected to lateral continuous or gustily wind. As has been already elaborated herein, vertical rudder 12A may be operated to limit or cancel the yaw angular moment 22B acting about AV CG point 400A by changing its angle to produce aerodynamic force 22C, substantially with same magnitude and opposite direction compared to yaw moment 22B.

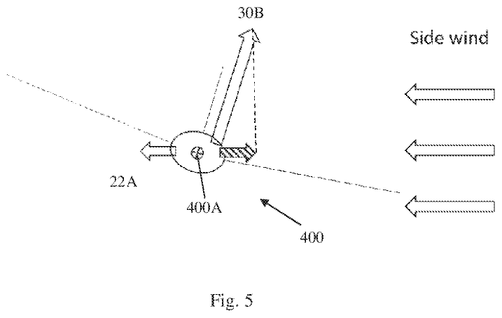

Reference is made now also to FIG. 5, which is a front-view schematic illustration of forces acting on an airborne vehicle (AV) 400 when subjected to lateral continuous or gustily wind. The total side force generated by the side wind 22A cannot be compensated by the vertical rudder alone, since the rudder is used to keep the aircraft heading aligned with the runway. Hence the aircraft must be banked in order to generate the lift force 30A with a horizontal projection 30B, which is of the same magnitude as 22A but in opposite direction.

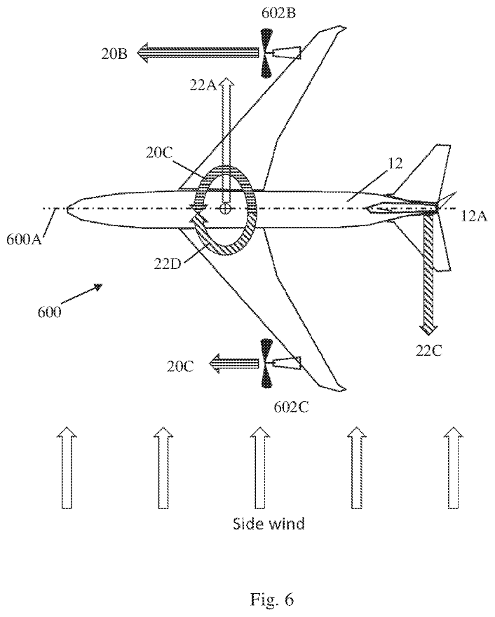

Reference is made now to FIG. 6, which is a top view schematic illustration of forces acting on an airborne vehicle (AV) 600, operative according to embodiments of the present invention, when subjected to lateral continuous or gustily wind.

The rudder 12A is deflected as required to generate a side force 22C, which is in the same magnitude but at opposite direction (with respect to the longitudinal central axis 600A of AV 600), to the wind induced side force 22A. The rudder deflection which generates the side force 22C is also generating a residual yawing moment 22D, working to divert the aircraft nose from being aligned with the runway or course of flight.

motors 602B and 602C may be controlled to generate different thrust vectors 20B and 20C, respectively. In the current example, the right-hand motor 602B generates increased thrust 20B, while the left-hand motor 602C generates respectively decreased thrust 20C. The thrust difference exerts a yawing moment 20C, which is set to be with the same magnitude but in opposite direction to the rudder generated residual yawing moment 22D, hence canceling the overall yawing moment and enabling generation of an overall decoupled side force (22C).

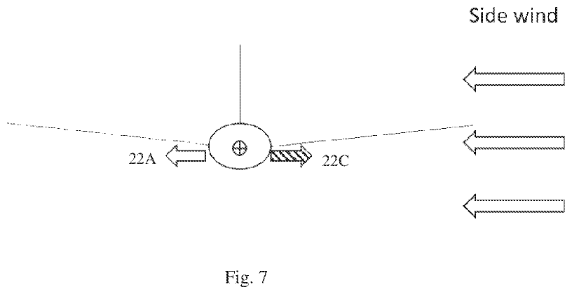

Reference is made now also to FIG. 7, which is a schematic illustration of forces exerted on AV 600 of FIG. 6. The decoupled side force 22C is opposing the wind generated side force 22A, enabling to land in view of cross wind with substantially zero bank angle, according to embodiments of the present invention. This enables keeping the aircraft heading aligned with the runway with zero bank angle.

In some embodiments a controller of the control system is adapted to continuously provide signals to at least one left and at least one right propeller electrical motor and optionally to control rudder position, so as to enable completing a landing procedure with AV roll angle no greater than two degrees in view of a cross wind that is up to 15% of the landing speed of the AV.

In some embodiments the controller of the control system is adapted to receive indications of ambient status, such as level of turbulences, winds and the like, ahead of the AV (with respect to the AV flight direction). The indications may be received one or more of several weather monitoring sources such as weather RADAR of the AV, a ground weather RADAR and wing member weather RADAR.

While certain features of the invention have been illustrated and described herein, many modifications, substitutions, changes, and equivalents will now occur to those of ordinary skill in the art. It is, therefore, to be understood that the appended claims are intended to cover all such modifications and changes as tall within the true spirit of the invention

1. A control system adapted to restrain turbulence induced yaw or side movements of a fully electrically propelled airborne vehicle (AV) having at least two electrical motors, disposed one on the left and one on the right side of a longitudinal central axis of the AV, the system comprising:
a controller adapted to steer the AV with fully electrically powered propelling based on:
receiving:
indications of ambient induced yaw and/or lateral movements of an airborne vehicle; and
pilot induced control signals of the airborne vehicle; and
issuing control signals to at least one of the at least two electrical motors of the fully electrically propelled AV adapted to compensate the effect of the ambient induced yaw and/or lateral movements.

2. The control system of claim 1 further adapted to:
calculate the required changes of thrust provided by propellers powered each by the at least two electrical motors to compensate for the at least one of yaw and/or lateral movements; and
provide control signals to at least one of the at least two electrical motors of the AV to effect the calculated required changes of thrust.

3. The control system of claim 1, further adapted to:
calculate the required changes of the angle of attack of a tail rudder of the AV to compensate for the at least one of yaw and/or lateral movements; and
provide the signals required to change the tail rudder angle of attack.

4. The control signals of claim 2 further translated to effect at least one of propellers pitch and/or propeller RPM.

5. The control system of claim 1, further adapted to:
calculate and provide the required control signals at a response time that is at least ten times faster than the time between yaw or lateral induced changes of movements.

6. A fully electrically propelled airborne vehicle (AV) having at least two electrical motors disposed one on the left side and one on the right of a longitudinal central axis of the AV, the fully electrically propelled AV comprising a yaw or side movement restrain system to allow stable flight in high flight speeds and/or bad weather conditions, the restrain system comprising:
a controller adapted to steer the AV with fully electrically powered propelling based on
receiving:
indications of ambient induced yaw and/or lateral movements of the airborne vehicle; and
pilot induced yaw control signals of the airborne vehicle; and
issuing control signals to at least one of the at least two electrical motors of the fully electrically propelled AV adapted to compensate the effect of the ambient induced yaw and/or lateral movements.

7. The fully electrically propelled AV of claim 6 wherein the restrain system is further adapted to compensate for effects of cross wind during landing or takeoff.

8. The fully electrically propelled AV of claim 7 wherein the restrain system is further adapted to compensate for effect of crosswind during landing so as to allow landing or takeoff at substantially zero roll angle.

9. A method for restraining ambient induced yaw or side movements in a fully electrically propelled airborne vehicle (AV) having at least two electrical motors disposed one on the left side and one on the right of a longitudinal central axis of the AV and a control system adapted to steer the AV with fully electrically powered propelling, the method comprising:
receiving by the control system indications of at least one of yaw and/or lateral movements;
calculating by the control system the required changes of thrust provided by at least one of the at least two electrically powered motors of the fully electrically propelled AV based on the received indications; and
continuously providing by the control system first signal to the at least one left and at least one right electrical motors, so as to minimize the effect of the yaw and/or side movement on the airborne vehicle.

10. The method of claim 9 wherein the side movements are due to crosswind during landing or takeoff, the method further comprising:
receiving by the control system lateral movement indications;
calculating by the control system the required changes of thrust provided by at least one of the at least two electrically powered propellers of the AV based on the received indications, and the required changes in the position of the tail rudder of the AV; and
continuously providing by the control system first signal to the at least one left and at least one right propeller electrical motors and rudder position, so as to enable completing the landing or takeoff with AV roll angle no greater than two degrees in view of a cross wind that is up to 15% of the landing speed of the AV.

11. The method of claim 10 further comprising:
calculating by the control system the required tail rudder change of angle of attack to direct the vehicle to a desired direction based on the received indications; and
continuously providing by the control system a second signal to the tail rudder so as to minimize the effect of the yaw and/or side movement on the airborne vehicle.

12. The method of claim 11 wherein the yaw and/or lateral movement indications are measured on the airborne vehicle.

13. The method of claim 11 wherein at least one of the yaw and/or the lateral movements are measured ahead of the airborne vehicle in the direction of its movement.

14. The method of claim 13 wherein the indications of the at least one of the yaw and/or the lateral movements are considered as reflecting ambient induced disturbances at a location that is distal, in time domain, from the airborne vehicle by time T1 and wherein the controller is adapted to calculate the required changes within time T2 that is at least 10 times shorter than T1.

15. The control system of claim 1 wherein the controller is further adapted to receive indications of ambient status ahead of the AV with respect to the AV flight direction, from at least one of the AV weather RADAR, a ground weather RADAR and wing member weather RADAR.

16. The control system of claim 1 wherein each of the two electrical motors is disposed in one form from a list consisting AV main wing, AV rear wing, AV V-tail stabilizer.
